(19) United States
(12) Patent Application Publication
(10) Pub. No.: US 2013/0265659 A1
(43) Pub. Date: Oct. 10, 2013

(54) Tip Tray With Magnifier

(71) Applicant: Takashi Kido, Carson, CA (US)

(72) Inventor: Takashi Kido, Carson, CA (US)

(21) Appl. No.: 13/443,840

(22) Filed: Apr. 10, 2012

(51) Int. Cl. G02B 27/02

(52) U.S. Cl. 359/802

(57) ABSTRACT

A tip tray with a magnifier for providing magnification, primarily of the restaurant bill. The magnifier may be embedded within the base of the tip tray or may be raised above the base of the tip tray for hands-free magnification. Multiple magnifications may be provided by having multiple magnifiers as part of the tip tray. For example, a 2x magnification power may be provided through one magnifier and 4x magnification power may be provided through another magnifier.

### BACKGROUND OF THE INVENTION

1. Field of the Invention

The present invention relates generally to a tip tray, and more particularly, to a tip tray with a magnifier.

2. Description of the Related Art

Restaurants generally will bring over the customer's bill, also known as the check, to the customer's table at the end of their meal. The bill is typically a printed sheet or hand written sheet of paper that list the line items, as well as the total, for the customer's order. This bill is typically on a sheet of paper that is about 2 cm to 8 cm in width, with the length possibly varying based on the number of line items. In most cases, this bill is presented either in a tip tray or a more formal check holder (also known as a check presentation cover or check cover).

Tip trays vary in size, and a typical one may be approximately 4.5 inch by 6.5 inch. The tip tray facilitates in completing the payment transaction process. As a start, the tip tray will contain the bill when presented to the customer. The customer can usually pay via cash or credit card by placing either form of payment within the tip tray. The restaurant's waiter will then take the tip tray, usually still containing the original bill, along with the form of payment provided by the customer. In the case where the form of payment is cash, the waiter will return with change provided in the tip tray. Often times, the change will include coins. The customer can then take the change and leave whatever tip is desired within the tip tray. In the case where the form of payment is a credit card, the waiter will return with a required signature page within the tip tray. The customer can usually write the tip amount to be processed as part of the credit card transaction or can leave cash as well. When cash tip is left, it is customary to leave it in the tip tray.

The common tip tray is rectangular, with rounded or sharp corners. Other shapes include square, oval, circular, and various other shapes. The common tip tray generally has a flat base and raised edges to prevent items, such as the bill, cash, and coins, from falling out of the tip tray. They may be of various colors, with the most popular being black. Written on the inside bottom of the tip tray may be a message, such as “Thank You.”

The standard tip tray is made of plastic, and may have different finishes, such as a glossy black finish. There are many variations to the material that may be used. For example, some form of metal may be used rather than plastic.

### SUMMARY OF THE INVENTION

Disclosed is a tip tray with an integrated magnifier that can be utilized to provide magnification of the restaurant check. This provides convenience, as the restaurant check is often presented in a conventional tip tray. The tip tray may now serve multiple functions, all of which are complementary to getting the restaurant's bill paid. In some embodiments, the magnifier may be embedded within a cut out of the tip tray, and in other embodiments may protrude as an extension of the tip tray.

### BRIEF DESCRIPTION OF THE DRAWINGS

A more complete appreciation of the invention and many of the advantages thereof will be readily obtained as the same becomes better understood by reference to the detailed description when considered in connection with the accompanying drawings, wherein:

FIG. 1 is a top view of a preferred embodiment of a tip tray with a magnifier.

FIG. 2 is a front view of a preferred embodiment of a tip tray with a magnifier.

FIG. 3 is a side view of a preferred embodiment of a tip tray with a magnifier.

FIG. 4 is a perspective view of a preferred embodiment of a tip tray with a magnifier.

FIG. 5 is a cross sectional view taken along the line 5-5 of FIG. 1.

FIG. 6 is a top view of a second embodiment of a tip tray with a magnifier.

FIG. 7 is a side view of a second embodiment of a tip tray with a magnifier.

FIG. 8 is a perspective view of a second embodiment of a tip tray with a magnifier.

FIG. 9 is a cross sectional view taken along the line 9-9 of FIG. 6.

FIG. 10 is a cross sectional view taken along the line 10-10 of FIG. 6.

### DETAILED DESCRIPTION

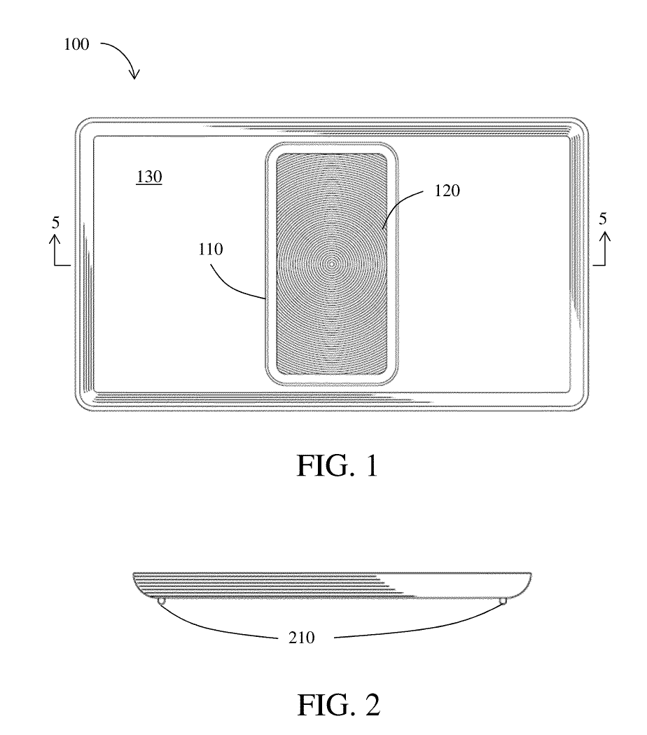

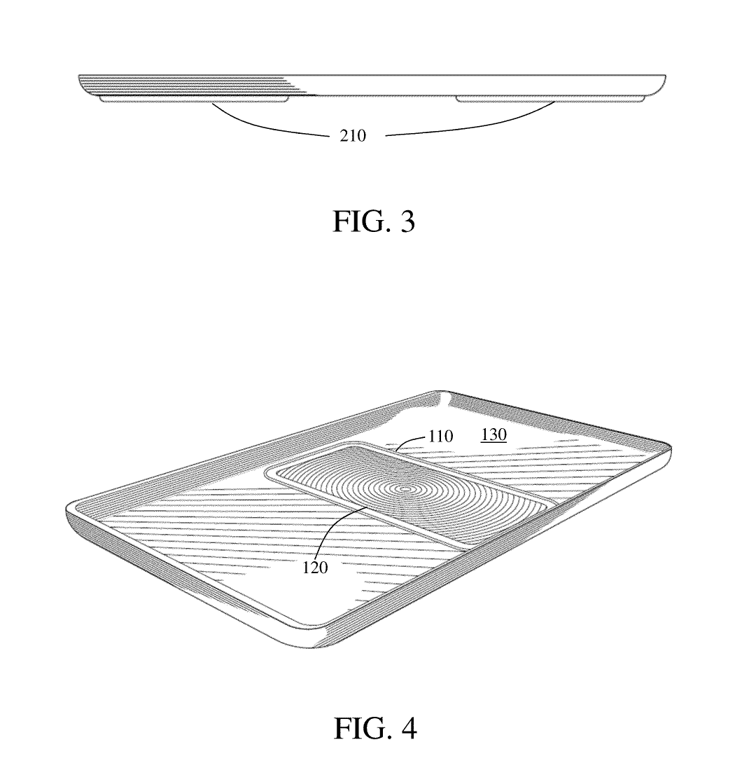

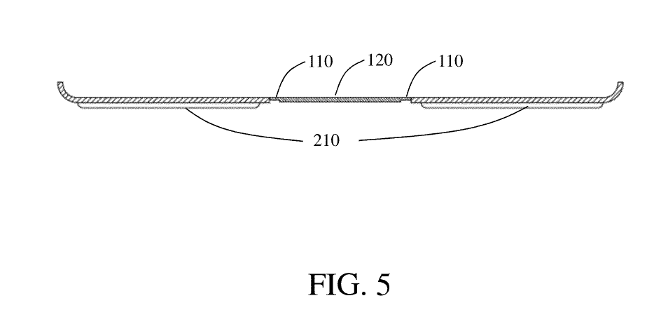

FIGS. 1-5 show a preferred embodiment of a tip tray with a magnifier 100. The tip tray in this preferred embodiment is rectangular with slightly rounded corners. As is common with most tip trays, the edges are raised to prevent items within the tip tray from falling out.

In this preferred embodiment, the magnifier 120 is manufactured separately from the tip tray 130. The magnifier 120 is generally a magnifying lens. The magnifier 120 is preferably made of acrylic (plastic). The alternative is glass. Acrylic lenses are preferred due to its lighter weight, durability, and less prone to scratching. One popular type of acrylic lenses is known as the Fresnel lens, which is generally very thin, lightweight, and permits a lot of light to transmit through the lens. All of these are desired characteristics for the magnifier of the preferred embodiment. However, one undesired characteristic of the Fresnel lens is that it is usually not as clear as other acrylic lenses or glass lenses. The Fresnel lens generally achieves magnification of 2x to 4x at a working distance of 5 cm to 12 cm from the subject. The working distance is the distance from the magnifier to the object viewed. Note, lx power magnification implies a 100% increase in magnification. Magnification power of 1.5x to 4x is desired in this preferred embodiment.

The magnifier 120 of this preferred embodiment is rectangular, but as one skilled in the art is aware, the magnifier may be a variety of shapes, with round and rectangular being the most common.

In this preferred embodiment, the magnifier 120 is placed into a cut out in the tip tray 130, specifically shaped to be a little smaller than the shape of the magnifier 120. The tip tray 130 has a depression around the cut out area, with the same shape of the magnifier. This allows the magnifier 120 to sit over the cut out, and fitted within the depressed area. A frame or bezel 110 is then placed over the edge of the magnifier 120, which is either snapped in place or an adhesive may be used to hold the magnifier 120 fixedly within the tip tray 130. There are a variety of other means for securing the magnifier 120 onto the tip tray 130. Another means may be a rubberized frame that may seal (via an outer seal) around a cut out (that is about a little larger than the size and shape of the magnifier), with an inner seal to hold the magnifier in place.

The tip tray preferably has legs 210 to protect the magnifier when the tip tray is placed on a flat surface.

The tip tray with a magnifier 100 may now easily be used by the restaurant patron to magnify the bill. This is done by holding the tip tray with magnifier above the bill and viewing the bill through the magnifier. Depending on the exact distance and magnification power of the lens, the restaurant patrons will now be able to more conveniently magnify and read the bill.

The preferred embodiment has a single magnifier. As noted, the magnifier has a particular shape and magnification power. In another embodiment, the tip tray may have multiple magnifiers, each with a different magnification power. This will be very useful and convenient in accommodating different restaurant patrons that require different levels of magnification. For example, the first magnifier may have a magnification power of 2x, and a second magnifier may have a magnification power of 4x. The two magnifiers may be placed in the tip tray in a variety of ways. One way may be to place the first rectangular magnifier on one end of the tip tray while placing a second rectangular magnifier on the other end of the tip tray. The different magnifiers do not necessarily need to be the same size. Another means of supporting two different magnifiers may be by manufacturing a single rectangular magnifier that has two different magnification powers. The first magnification power may be 2x which, while the second magnification may be 4x, and this second magnification may be at one corner of the rectangular magnifier. The same principle may be applied for multiple magnification powers, beyond two, within a magnifier.

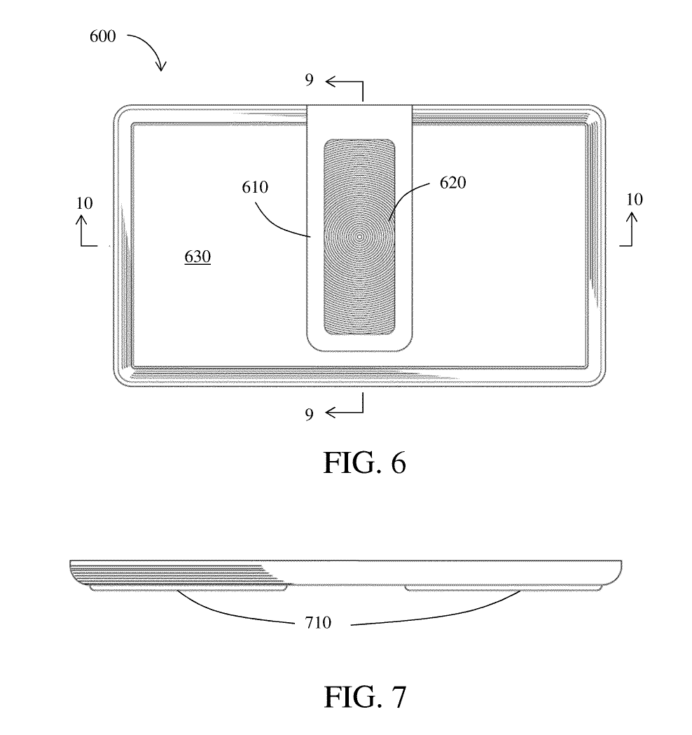

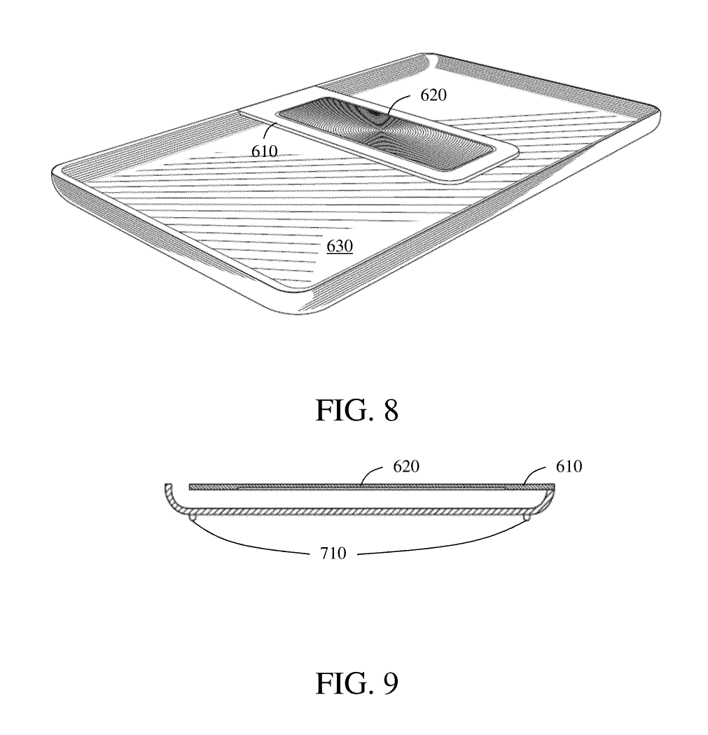

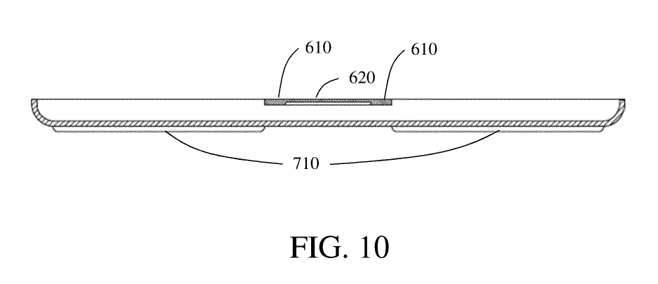

FIGS. 6-10 show a second embodiment of a tip tray with a magnifier 600. The main difference between this second embodiment and the preferred embodiment is the raised, hands-free nature of the magnifier. The magnifier 620 is placed within a raised surface 610. The raised surface 610 is raised relative from the base of the tip tray 630. In this embodiment, the raised surface 610 is fixedly attached to the upper edge of the tip tray 630. In other embodiments, the raised surface 610 may be raised even higher by extending higher from the upper edge of the tip try 630, and then bending inwards to form the raised surface. The raised surface 610 may integrate with the magnifier in a variety of ways, such as those described in the preferred embodiment. The working distance (focal length) of the magnifier should accommodate the distance between the magnifier 620 and the inside bottom of the tip tray 630. Generally, for about 3.5X magnification power, the raised surface 610 should be about 10 cm above the inside bottom of the tip tray 630.

The convenience of this second embodiment is that the bill may stay within the tip tray and may be magnified in a hands-free manner. A hands-free manner refers to not having to handle the magnifier. Rather, the subject (the bill), is handled while the magnifier stays stationary. Multiple magnifications may be supported by having multiple raised surfaces with differing magnification powers.

Although the present invention has been described in detail with respect to certain embodiments and examples, variations and modifications exist which are within the scope of the present invention as defined in the following claims.

What is claimed is:

1. A tip tray comprising:
a base with raised edges; and
a magnifier embedded in said base.

2. The tip tray of claim 1 wherein said magnifier is comprised of an acrylic lens.

3. The tip tray of claim 2 wherein said magnifier achieves magnification between 2x and 4x.

4. The tip tray of claim 3 wherein said magnifier has a working distance between 5 cm and 12 cm.

5. The tip tray of claim 4, wherein said base is flat and rectangular and further comprising legs at the bottom of said base.

6. The tip tray of claim 5, wherein said magnifier is rectangular.

7. The tip tray of claim 6 wherein said base has a cut out area and a depression around said cut out area to fit said magnifier in said depression.

8. The tip tray of claim 7 further comprising of an adhesive to fixedly attach said magnifier within said depression.

9. The tip tray of claim 7 further comprising of a bezel placed over the edges of said magnifier to fixedly attach said magnifier to said base.

10. The tip tray of claim 6 wherein said base has a cut out area and further comprising a rubberized frame comprised of an outer seal attached around said cut out area and an inner seal attached around said magnifier.

11. The tip tray of claim 1 wherein said magnifier is comprised of a first magnifier with a first magnification power and a second magnifier with a second magnification power.

12. The tip tray of claim 1 further comprising a second magnifier embedded in said base.

13. A tip tray comprising:
a base with raised edges;
a raised surface fixed attached to said base; and
a magnifier embedded within said raised surface.

14. The tip tray of claim 13 wherein said magnifier is comprised of an acrylic lens.

15. The tip tray of claim 14 wherein said magnifier has a working distance of between 1 cm and 10 cm.

16. The tip tray of claim 15 wherein said magnifier achieves magnification between 2x and 5x.

17. The tip tray of claim 13 further comprising a second raised surface fixed attached to said base and a second magnifier embedded within said second raised surface.

18. The tip tray of claim 13 further comprising a second magnifier embedded within said raised surface.

19. The tip tray of claim 13 wherein said magnifier is comprised of a first magnifier with a first magnification power and a second magnifier with a second magnification power
